(19) United States
(12) Patent Application Publication
(10) Pub. No.: US 2006/0030182 A1
(43) Pub. Date: Feb. 9, 2006

(54) Patient presence monitoring system and method

(75) Inventors: Wyndham F. Gary JR., Whitefish Bay, WI (US); Chris M. Hofmeister, Menomonee Falls, WI (US); Jeff C. Krueger, Waukesha, WI (US); Robert C. Hall JR., Brown Deer, WI (US); John LaBorde, Oconomowoc, WI (US)

Correspondence Address: FOLEY & LARDNER LLP, 777 EAST WISCONSIN AVENUE, SUITE 3800, MILWAUKEE, WI, 53202-5308, US

(73) Assignee: RF Technologies, Inc.

(21) Appl. No.: 11/192,328

(22) Filed: Jul. 28, 2005

Related U.S. Application Data
(60) Provisional application No. 60/592,085, filed on Jul. 29, 2004.

(51) Int. Cl. H01R 13/648

(52) U.S. Cl. 439/95

(57) ABSTRACT

A sensing system is disclosed. The sensing system includes a capacitive sensing pad comprising a first conductive layer and a second conductive layer. A clip is engageable with the pad and comprises a first conductor and a second conductor. The first conductor is configured to conductively engage the first conductive layer and the second conductor is configured to conductively engage the second conductive layer when the clip is engaged with the pad.

### CROSS-REFERENCE TO RELATED APPLICATIONS

This application claims priority to U.S. Provisional Patent Application No. 60/592,085 entitled PATIENT PRESENCE MONITORING SYSTEM AND METHOD, filed on Jul. 29, 2004, which is herein incorporated by reference in its entirety.

### BACKGROUND

The invention generally relates to a monitoring apparatus for monitoring the presence of a patient using supporting structures such as a bed, a chair, or like supporting device. Patients may often be restricted to a bed, chair, or other supporting structure for various reasons, primarily related to their well being and safety. Therefore monitoring in such situations may be significantly important in a restricted free environment for protecting the dignity of the patients or residents. Additionally, a patient may at times refuse conforming to restricted requirements, or may accidentally or inadvertently attempt to move themselves because they forget the ability to make a rational decision is impaired or the like, which may prevent following instructions. Bed and chair alarms exist generally to create alarms when a person is attempting to stand up from a chair, bed, or other supporting structure. These devices generally can be found in assisted living, skilled nursing, and hospital settings, where the risk of falling is greater due to age or impairment. Falls may result in significant injury or possibly even result in death.

Conventionally, these alarm systems may utilize any of several technologies to determine the presence of people on the bed, chair, or supporting structure and their lack of presence on the bed, chair, or structure and signaling of an alarm. In one example of the technology (U.S. Pat. No. 5,410,297), capacitance measurement between two conductive layers separated by a compressible material and a pad enclosure provides the sensor input to a control unit.

In such a system, the pad is generally connected to the control unit's reel cable. The cable is permanently attached to the pad and is disposable with the pad. These cables can become wrapped around the wheelchair wheels and caught in articulating beds damaging the cables, resulting in additional alarms, damaged controllers, and premature pad life. Further, the use of such cables and full use of a cable with a cable connector may make the cost of the pad unnecessarily high and further may waste resources as the pad is typically a disposable unit.

Accordingly, there is a need for a pad which does not require a cable. Further, there is a need for a sensing pad which utilizes a clip that provides a conductive path to the capacitive device. Further still, there is a need for a clip with conductive teeth, that when clipped onto the edge of the sensor pad, pierces the outer layer of the pad and individually makes contact with the upper and lower conductive layers within the pad. Further still, there is a need for a clip that may contain a wire to relay the signal back to a controller, or alternatively a clip in which a controller may be self contained. Further still, there is a need for a clip for a sensor pad that may also contain multiple teeth sets to connect and sense multiple areas within the pad. Yet further still, there is a need for a clip that may provide alarms locally or through radio frequency (RF) transmission to another system. Yet further still, there is need for a system in which multiple areas of the pad allows pre-alarms to be triggered as the patient or person moves or approaches the edges of the pad.

It would be desirable to provide a system and/method that provides one or more of these or other advantageous features. Other features and advantages will be apparent from the present specification. The teachings disclosed extend to those embodiments which fall within the scope of the appended claims, regardless of whether they accomplish one or more of the aforementioned needs.

### SUMMARY

What is provided is a sensing system. The sensing system comprises a capacitive sensing pad. The capacitive sensing pad comprises a first conductive layer and a second conductive layer. The sensing system also comprises a clip engageable with the pad. The clip also comprises a first conductor and a second conductor. The first conductor is configured to conductively engage the first conductive layer and the second conductor is configured to conductively engage the second conductive layer when the clip is engaged with the pad.

What is also provided is a method of sensing. The method comprises providing a capacitive pad. The pad comprises at least two conducive layers disposed within an outer layer and having a substantially insulating layer disposed between at least two conductive layers. The method also comprises clipping a clip to the pad. The clip has at least two conductors. Each of the conductors pierces the outer layer and each of the conductors contacts a different conductive layer in the pad. Further, what is provided is a sensing pad clip. The sensing pad clip comprises a first member and a second member. A pivot couples the first member and the second member. A biasing device biases the first member and the second member to a pad engagement position. A first conductor is coupled to the first member. The first conductor is substantially sharp to pierce an outer layer of a sensing pad. A second conductor is coupled to the second member. The second conductor is substantially sharped to pierce an outer layer of the sensing pad.

Alternative examples and other exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an exemplary block diagram of a sensor pad system;

FIG. 2 is an alternative exemplary embodiment of a sensor pad system;

FIG. 3 is an exemplary embodiment of a sensor pad and clip;

FIG. 4 is an alternative exemplary embodiment of a sensor pad and clip;

FIG. 5 is an exemplary embodiment of a sensor pad; and

FIG. 6 is an exemplary block diagram of a sensor pad controller or clip.

### DETAILED DESCRIPTION OF PREFERRED AND EXEMPLARY EMBODIMENTS

Before describing in detail the particular improved system and method, it should be observed that the invention includes, but is not limited to a novel structural combination of conventional data/signal processing components and communications circuits, and not in the particular detailed configurations thereof. Accordingly, the structure, methods, functions, control and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

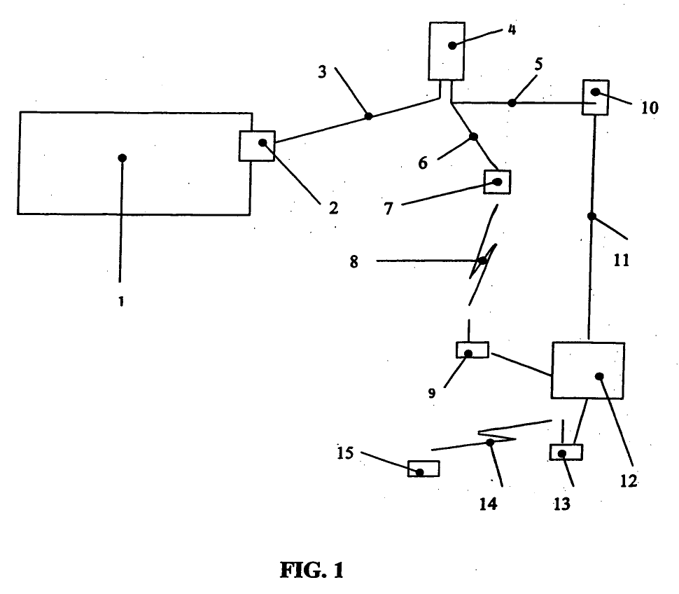

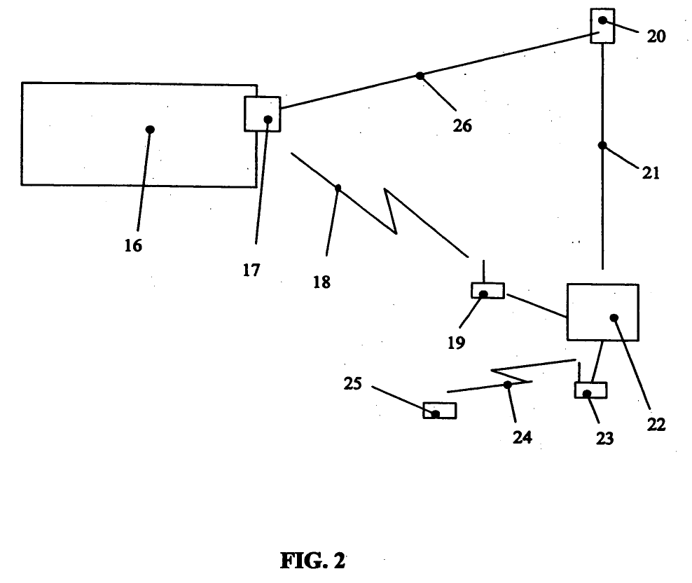

Referring now to FIG. 1, a sensor pad 1 is depicted in a nurse call environment, for example. The environment in which the sensor pad may be used may be in any of a variety of environments including a home, a nursing home, a hospital, but is not limited thereto. Sensor pad 1 is coupled to a clip 2 which may be clipped onto pad 1 and connected to a controller 4 by a cable 3. Controller 4 may also be further connected to a nurse call system via a cable 5, wall plate 10, and wire 11 to a central nurse call computer 12. Alternatively, a controller may be connected to a nurse call system through a cable 6 to radio frequency transmitter 7, which transmits a radio frequency message 8 to a radio frequency receiver 9 attached to the nurse call computer 12. Nurse call computer 12 may further be connected to a radio frequency transmitter 13 which is configured to transmit radio frequency message 14 onto a radio frequency receiver 15 that may be carried by a nurse or other staff member who is responsible for monitoring the patient and/or status of sensor pad 1. Referring now to FIG. 2, an alternative embodiment of a sensor pad 16 in a nurse call environment is depicted. A clip 17 couples to pad 16 having the controller functionality built into clip 17. Clip 17 upon detection of an alarm condition may transmit a radio frequency transmission 18 to a radio frequency receiver 19 which may be in communication with nurse call computer 22. Nurse call computer 22 may further be connected to a radio frequency transmitter 23, which transmits the radio frequency message 24 onto a radio frequency receiver 25 carried by a nurse or other staff member.

Alternatively, clip 17, which again includes the controller functionality, may be clipped onto pad 16. Upon alarm, the controller of clip 17 will signal a nurse call system through a cable 26, wall plate 20, and wire 21 to a central nurse call computer 22. Nurse call computer 22 may further be connected to an RF transmitter 23 which transmits an RF message 24 onto an RF receiver 25 carried by the nurse or other staff member.

It should be noted that any of the cable connections shown or depicted may be replaced by wireless connections including, but not limited to RF or optical links.

Pads 1 and 16 depicted in FIGS. 1 and 2 may be disposable pads which comprise multiple layers including conductive layers and insulating layers between the conductive layers. Pads may be disposed of periodically, or when they become soiled. Accordingly, it is beneficial to dispose of as little material as possible thus, the use of a clip represented by clips 2 and 17 is attractive due to the fact that when it is time to dispose of pads 1 or 16, the pad, without the clip, may be disposed of thus enabling the clip to be reused. In particular, clip 17 includes electronic devices which increase the cost of clip 17 and therefore necessitate its reuse.

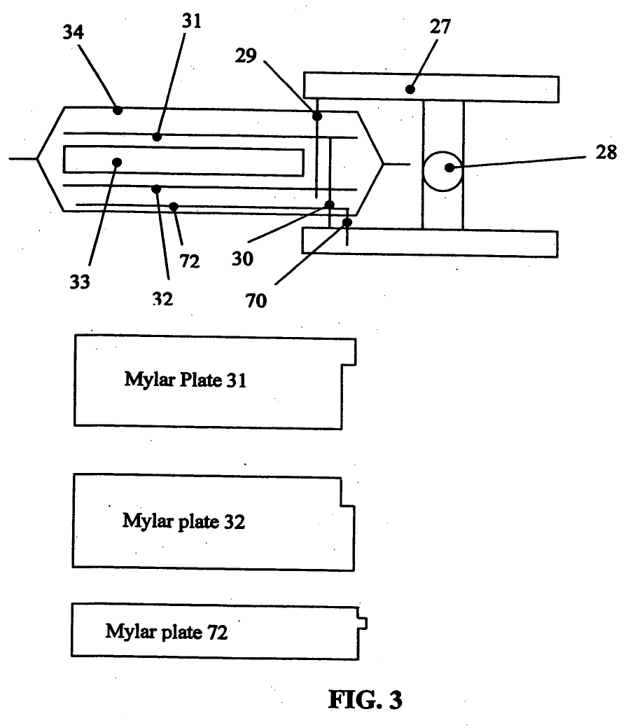

Referring now to FIG. 3, a cross sectional view of a clip 27 and a pad 34 is provided. In accordance with an exemplary embodiment, clip 27 comprises a hinge 28. A top portion and a bottom portion of clip 27 may pivot around the hinge point 28. Hinge 28 may be spring loaded in such a way as to bias clip 27 into a closed position. Squeezing the ends of the clip opposite teeth 29 and 30, may provide adequate force to open the clip in such a way so that the teeth 29 and 30 portion of clip 27 may clip over the end of pad 34. Upon release of the clamp, the spring-loaded hinge 28 closes the clip about hinge point 28 and teeth 29 and 30 which may be coupled to clip 27 pierce the outer layer of pad 34 to make conductive contact with conductive plates 31 and 32.

Plates 31 and 32 may be plastic Mylar sheets having a conductive coating on one surface. The ends of each sheet (or plate) may be cut (or alternatively folded back) to expose the conductive surface to conductive teeth 29 and 30 and clip 27. In an exemplary embodiment, both plates 29 and 30 may be the same length in which to create a single area. A foam 33 or other insulating material may be disposed between plates 31 and 32. As the pad is compressed by a person or a patient sitting or lying on the pad, the presence of the capacitance of the pad changes and therefore can be sensed by the controller and computer. In an exemplary embodiment of the controller which would be applicable in the disclosed system is described in detail in U.S. Pat. No. 5,410,297, entitled “Capacitive Patient Presence Monitor,” which is herein incorporated by reference.

In the exemplary embodiment shown, if pad 34 becomes soiled or otherwise requires changing, clip 27 may be disengaged from pad 34 by squeezing the ends and opening the teeth portion of clip 27. As stated earlier in one exemplary embodiment, clip 27 may be in wireless communication with a computer system or alternatively, clip 27 may have a cable coupled thereto. Clip 27 may also include controller electronics, or be coupled to controller electronics which are exterior to clip 27.

In accordance with an alternative exemplary embodiment, it may be desirable to have a measurement of the capacitance between plate 31 and plate 72. This may be accomplished by providing clip 27 with another tooth or set of conductive teeth 70 which are configured to engage plate 72. The measurement between plates 31 and 72 may be used to provide a reference capacitance measurement. The reference measurement in combination with the other capacitance measurements may be used to detect motion of the patient on the pad. Accordingly, not only position may be established, but motion of the patient may be detected and tracked.

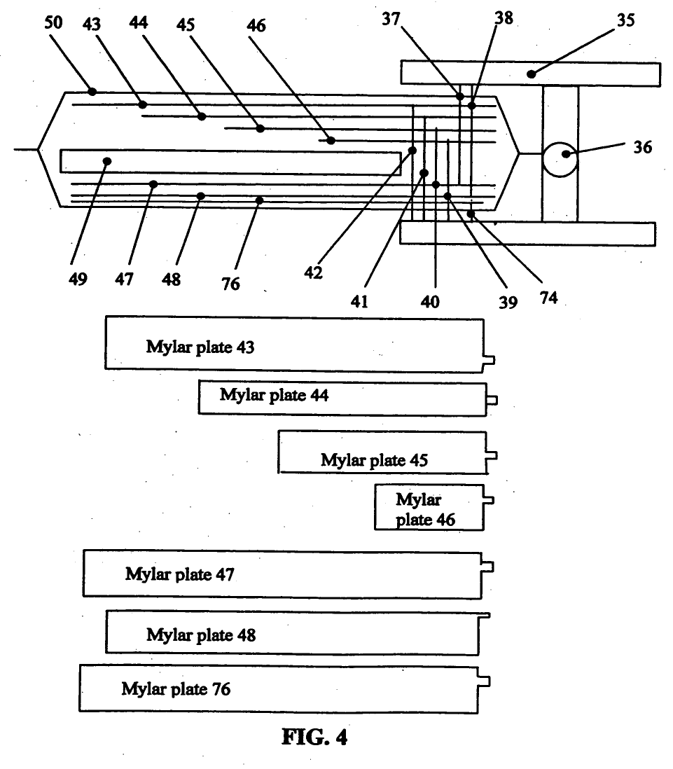

Referring now to FIG. 4, a cross sectional view of an alternative embodiment of a clip 35 and a pad 50 and the connection between them is depicted. Pad 50 comprises multiple layers, sheets, or plates 43, 44, 45, 46, 47, and 48. Similar to the embodiment depicted in FIG. 3, clip 35 pivots around a hinge point 36, which may be spring loaded to clip 35 shot. Squeezing the ends may open clip 35 which allows clip 35 to slip over the end of pad 50. Upon release of the clamp, the spring closes the clip above its hinge point 36 and the upper teeth (37 and 38) embedded in clip 35 pierce the outer layer of pad 50 and make contact with conductive plates 47 and 48, and the lower teeth (39, 40, 41 and 42) embedded in clip 35 pierce the outer layer of pad 50 and engage sheets 40, 41, and 42 and make contact with conductive plates 43, 44, 45 and 46.

Pad 50 may be provided with multiple plates or sheets 43, 44, 45, 46, 47, and 48 in order to provide sensing of different areas of the pad. Plates 43-48 may be made of plastic Mylar with a conductive coating on one surface, or other suitable material. The ends of plates 43, 44, 45, 46, 47, and 48 may be cut to expose the conductive surface to the conductive teeth 37, 38, 39, 40, 41, and 42 and clip 35. Each plate may be provided with a different length or width to create separate areas. Plates 43 and 48 may be full length and width, for example. Plate 44 may be three-quarters length and full width, for example. Plate 43 may be half length and full width, for example. Plate 46 may be quarter length and full width, for example. Plate 47 may be full length and half width. In such a configuration, eight areas having different nominal capacitance are created.

In accordance with an alternative exemplary embodiment, it may be desirable to have a measurement of the capacitance between plate 43 and plate 76. This may be accomplished by providing clip 35 with another tooth or set of conductive teeth 74 which are configured to engage plate 76. The measurement between plates 43 and 76 may be used to provide a reference capacitance measurement. The reference measurement in combination with the other capacitance measurements may be used to detect motion of the patient on the pad. Accordingly, not only position may be established, but motion of the patient may be detected and tracked.

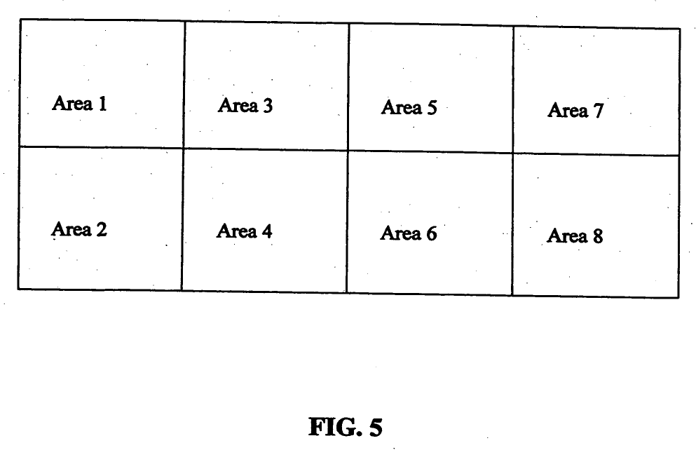

For example, FIG. 5 depicts an exemplary embodiment of a sensor pad in which it is divided up into eight areas, area 1 to area 8. In such a situation as depicted in FIG. 4, measuring the capacitance between plate 43 and 47 senses area 1. Measuring the capacitance between plate 43 and 48 senses area 2. Measuring the capacitance between plate 44 and 47 senses area 3. Measuring the capacitance between plate 44 and 48 senses area 4. Measuring the capacitance between plate 45 and 47 senses area 5. Measuring the capacitance between plate 45 and 48 senses area 6. Measuring the capacitance between plate 46 and 47 senses area 7. Measuring the capacitance between plate 46 and 48 senses area 8.

In the embodiment shown, it may be desirable to provide a clip in which the teeth are at the top versus the bottom portion of the clip are offset from each other such that when the clip is disconnected from the pad, the teeth do not touch each other and the clip's biased closed position. If the teeth are configured not to touch, then it may be relatively simple to sense when the clip has been removed from the pad.

In summary, a clip is provided with conductive teeth in combination with a sensor pad. The clip clips onto the edge of the sensor pad, pierces the outer layer of the pad and individually makes contact with the upper and lower conductive layers within the pad. The clip may comprise a wire to relay the signal back to a controller, or alternatively the clip may contain a controller therein. The clip may also contain multiple teeth sets to connect and sense multiple areas within the sensor pad. The clip may alarm locally or through radio frequency transmission. Additionally, if the clip is removed or a weight is sensed on the pad, the clip may be configured to provide an alarm.

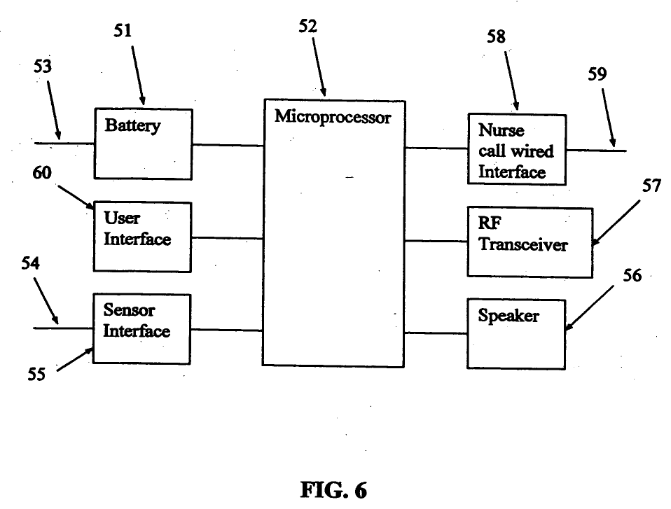

Referring now to FIG. 6, and exemplary hardware block diagram of a controller or clip. The controller or clip is powered by a battery 51, or alternately by a power cord 53. A sensor interface 55 either connects to a sensor pad through a cable 54 in the case of a controller or directly through the teeth of the clip. A microprocessor 52 automatically detects the presence of weight on the pad through the sensor interface and begins monitoring the patient. When the patient is no longer present on the pad, the microprocessor creates an alarm after a programmable delay period. The alarm is sent out via the speaker 56, the nurse call relay 58 to the nurse call system cable 59, and/or through the RF transceiver 57. The user interface 60 allows the user to adjust the delay, the speaker volume, and to silence the alarm. Alternately the user interface parameters can be controlled through the RF Transceiver 57 by the remote nurses station.

Delay may be defined as the time since the last movement is detected on the sensor pad, or time after weight is removed from the sensor pad before an alarm is created. Delay can be adjusted based on the time of day. At night the delay for last movement may be significantly longer than for daytime activity. Delay of alarm can also be controlled through the RF transceiver 57. The source of the change may be from a Nurse Call system or from other devices associated with the patient.

User interface 60 may be configured to allow the user to identify the position (orientation of the patient on the pad or orientation of the pad relative to the patient) of the patient on the pad. The position detected is communicated through RF transceiver 57 to a nurse call computer (such as nurse call computer 22 of FIG. 2). Microprocessor 52, using e.g. plate 72 and 76 in FIGS. 3 and 4 respectively, may be configured to detect motion on the pad and communicate that motion through user interface 60. When the patient moves or is moved on the pad, microprocessor 52 detects the motion and sends the motion information through RF transceiver 57 to nurse call computer 22 on and event and periodic basis. Software running on microprocessor 52 or other processors on the system may be configured to provide both tracking and visualization of the movement. This motion information may be used for making sure that patients, who may be susceptible to bedsores if not periodically moved or rotated, regularly have their position changed. If, for example it has been determined that the patient has not moved or been reoriented within a predetermined time period, an alert is provide to indicate that the patient requires rotation or movement.

An exemplary advantage of the clip over conventional designs of sensor pads is the potential for elimination of cabling from the pad which thereby reduces the cost of the disposable pad, eliminating cable failures, pad failures, controller damage, and reducing resultant false alarms. In an exemplary embodiment, it may be prudent to provide an alignment mechanism on the outside of the pad to make the connection between the clip and the pad directly each and every time. Such an alignment mechanism may include, but is not limited to the markings on the outside of the pad. Further, it may be desirable to provide an adhesive which holds the folded end of the conductive layers in place. Further, in an alternative embodiment, a pattern on the sensor area of the pad may be provided such that the pad can be used on articulated beds or chairs in which the pad is to be bent. For example, it may be desirable to have separate zones of the pad in which a crease or fold area down the middle of the may not contain the conductive layers.

In accordance with another exemplary embodiment, the clip may be connected to a walkie talkie or similar radio device. Upon sensing an alarm condition the clip will use the call feature of the walkie talkie to send a call tone to a staff member, as well as place the walkie talkie in an audio voice activation mode. The care giver will receive the call tone and upon receiving the tone use their walkie talkie to begin an immediate conversation with the patient, instructing them to lay or sit back down and that help is on the way. The clip through its two way RF communication with the nurse call computer may also automatically select a free walkie talkie channel.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing and/or communication devices. For example, the type of computing or communications device used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A sensing system, comprising:
a capacitive sensing pad comprising a first conductive layer and a second conductive layer;
a clip engageable with the pad and comprising a first conductor and a second conductor, the first conductor configured to conductively engage the first conductive layer and the second conductor configured to conductively engage the second conductive layer when the clip is engaged with the pad.

2. The sensing system of claim 1, wherein the pad comprises an outer layer substantially encasing the first and second conductive layers.

3. The sensing system of claim 2, wherein either or both of the first conductor and the second conductor pierces the outer layer when the clip is engaged with the paid.

4. The sensing system of claim 1, wherein the first conductive layer and the second conductive layer are separated by a substantially non conductive third layer.

5. The sensing system of claim 4, wherein the third layer is a foam layer.

6. The sensing system of claim 1, further comprising:
a biasing mechanism, biasing the clip in the closed position.

7. The sensing system of claim 6, wherein the biasing mechanism comprises a spring.

8. The sensing system of claim 1, wherein the clip comprises a controller circuit formed as a portion of the clip.

9. The sensing system of claim 1, wherein at least some of the first conductor and the second conductor are formed as teeth.

10. The sensing system of claim 1, wherein the conductive layers comprise a sheet-like plastic material coated with a conductive coating.

11. The sensing system of claim 10, wherein the plastic material comprises Mylar.

12. The sensing system of claim 1, wherein the pad comprises more than two conductive layers and the clip has as many conductors as the number of conductive layers of the pad.

13. The sensing system of claim 1, wherein the clip comprises a radio frequency transmission circuit.

14. A method of sensing, comprising:
providing a capacitive pad, the pad comprising at least two conductive layers disposed within an outer layer and having a substantially insulating layer disposed between the at least two conductive layers;
clipping a clip to the pad, the clip having at least two conductors, each of the conductors piercing the outer layer and each contacting a different conductive layer in the pad.

15. The method of claim 14, further comprising:
initiating communications with the clip, the clip comprising a controller circuit.

16. The method of claim 14, further comprising:
disengaging the clip from the pad.

17. The method of claim 16, further comprising:
disposing of the pad.

18. The method of claim 17, further comprising:
engaging a replacement pad with the clip.

19. The method of claim 14, further comprising:
detecting an alarm state by a controller.

20. The method of claim 19, further comprising:
transmitting wirelessly from the controller, the alarm sate.

21. A sensing pad clip, comprising:
a first member;
a second member;
a pivot coupling the first member and the second member;
a biasing device, biasing the first member and the second member to a pad engagement position;
a first conductor coupled to the first member, the first conductor being substantially sharp to pierce an outer layer of a sensing pad; and
a second conductor coupled to the second member, the second conductor being substantially sharp to pierce an outer layer of the sensing pad.

22. The sensing pad clip of claim 21, further comprising:
a controller circuit configured to sense an alarm condition.

23. The sensing pad clip of claim 21, further comprising:
a radio frequency transmission circuit.

24. A method of sensing, comprising:
providing a capacitive pad, the pad comprising at least two conductive layers disposed within an outer layer and having a substantially insulating layer disposed between the at least two conductive layers;
measuring the capacitance between conductive layers in the pad
determining the position of a patient based on the measured capacitances between various layers in the pad.

25. The method of claim 24, further comprising:
initiating communications between the pad and a controller circuit.

26. The method of claim 24, further comprising:
determining the motion of a patient relative to the pad based on the measured capacitances between various layers in the pad.

27. The method of claim 24, further comprising:
providing a conductive layer in the pad which is configured to provide a reference capacitance when measured between the reference layer and another conductive layer in the pad.

28. The method of claim 26, further comprising:
providing an alert to a user if no motion is detected during a predetermined period.

29. The method of claim 26, further comprising:
visualizing on a display the motion of a patient relative to the pad.

30. The method of claim 26, further comprising:
tracking the motion of a patient relative to the pad.
